(19) United States
(12) Patent Application Publication
(10) Pub. No.: US 2024/0306712 A1
(43) Pub. Date: Sep. 19, 2024

(54) CONVECTION AND CONDUCTION HEATER FOR A VAPORIZER

(71) Applicant: STORZ & BICKEL GMBH, Tuttlingen (DE)

(72) Inventors: MARKUS HANS STORZ, Tuttlingen (DE); ROBERT JAGER, Krauchenweis (DE); ROY MARKUS GASSENFEIT, Zimmern ob Rottweil (DE); STEFFEN FABIAN MAUCH, Tuttlingen (DE); STEPHAN TOBIAS ROTH, Tuttlingen (DE)

(21) Appl. No.: 18/121,081

(22) Filed: Mar. 14, 2023

(51) Int. Cl. A24F 40/46; A24F 40/51; H05B 3/46

(52) U.S. Cl. CPC A24F 40/46; A24F 40/51; H05B 3/46; H05B 2203/016

(57) ABSTRACT

A heater assembly designed for use with a vaporizer. The heater assembly including a housing with a heat exchanger. The heat exchanger extends from a first end to a second end. The heat exchanger defines at least one air flow path that extends through the heat exchanger from the first end to the second end. The housing is configured to retain a substance adjacent the second end for heating. A heating element extends around at least a portion of the air flow path with a portion of the heat exchanger positioned between the heating element and the air flow path. The heating element is configured to heat the heat exchanger, and the heat exchanger is configured to transfer heat from the heating element to air flowing through the air flow path from the first end to the second end. Alternatively, the heat exchanger heats as electric current flows through it.

### CROSS-REFERENCE TO RELATED APPLICATIONS

Not applicable.

### BACKGROUND OF THE INVENTION

There are a variety of different types of vaporizers that are designed to heat a substance until portions of the substance vaporize for inhalation by a user. Some types of commercially available vaporizers are designed to heat the substance via both convection and conduction or radiation. Such vaporizers, however, are often fairly large due to the relatively large space needed to heat air flowing through the vaporizer to a temperature effective to convectively heat the substance to a desired temperature. Many commercially available vaporizers also do not uniformly heat the substance, which may cause an unequal temperature distribution among portions of the substance and overheating of portions of the substance. Overheating the substance may impact the taste of the vaporized substance, e.g., the vaporized substance may taste like it is burnt. Under heating may lead to waste of the substance as not all portions of the substance will be used. Inconsistent temperature distribution may further frustrate the user as the result of vaporization will vary each time the device is used. Further, many commercially available vaporizers may require a relatively high amount of electric power to effectively heat the air for convective heating. Many commercially available vaporizers may also take a long time to heat the substance to the desired temperature necessary for vaporization of desired compounds of the substance, and/or fail to maintain such temperature within a desired range of temperatures over a desired timeframe and range of air flow rates, which may vary from user to user and sometimes even from one session to another due to different application (e.g., preferred usage during work may be different from preferred usage at home).

### BRIEF SUMMARY OF THE INVENTION

A heater assembly for a vaporizer in accordance with one aspect of the invention described herein includes a housing with a heat exchanger that extends from a first end to a second end. The heat exchanger defines at least one air flow path that extends through the heat exchanger from the first end to the second end. The housing is configured to retain a substance adjacent the second end for heating. For example, the housing may have a screen that supports the substance above the air flow path through the heat exchanger. A heating element extends around at least a portion of the air flow path with a portion of the heat exchanger positioned between the heating element and the air flow path. The heating element is configured to heat the heat exchanger, and the heat exchanger transfers heat from the heating element to air flowing through the air flow path from the first end to the second end.

In some embodiments, the heating element may comprise a resistance wire that is wrapped around at least a portion of an outer wall of the heat exchanger. The heat exchanger may include an electrically non-conductive insert coupled to the outer wall. The resistance wire may engage the insert at a location where the resistance wire changes direction. The insert may reduce the likelihood of short circuits at locations where the resistance wire bends around edges of the heat exchanger. For example, if the heat exchanger includes an anodized outer surface (for electrical isolation) that may be susceptible to damage along edges of the heat exchanger, the resistance wire may engage the insert at locations where the resistance wire changes direction so that the resistance wire is not in contact with an edge of the anodized outer surface. The resistance wire may have a first end and a second end. The resistance wire may extend from the first end through a channel in the insert toward the second end of the heat exchanger. The wire may extend from the channel around the outer wall in a helical manner toward the first end of the heat exchanger and the second end of the wire. The insert may be formed from a ceramic material. The heater assembly may include a microcontroller configured to monitor a resistance of the resistance wire if the resistance of the wire changes with its temperature. The microcontroller may be configured to determine when air is flowing through the air flow path based on changes in the resistance.

In some embodiments, the resistance wire may include a series of spaced apart rings each wrapped around at least a portion of the outer wall of the heat exchanger with each ring connected to a first electrical lead and a second electrical lead. In other embodiments, the resistance wire may extend from a first end around a portion of the outer wall on one side of the heat exchanger toward the second end of the heat exchanger and then around a portion of the outer wall on an opposite side of the heat exchanger toward the first end of the heat exchanger and a second end of the wire.

In some embodiments, the heating element may be at least one of a heater that is wrapped around at least a portion of an outer surface of the heat exchanger, a ceramic heater, a resistance wire embedded in ceramic, a positive temperature coefficient heater, a negative temperature coefficient heater, a film printed conductor on an outer surface of the heat exchanger, or a conductive material that is joined to the outer surface of the heat exchanger, for example, by laser sintering.

In some embodiments, the air flow path through the heat exchanger may comprise a plurality of channels extending through the heat exchanger from the first end to the second end. The heating element may extend around at least a portion of each of the channels with a portion of the heat exchanger positioned between the heating element and each of the channels.

In some embodiments, an outer surface of the heat exchanger may be at least one of anodized aluminum or ceramic. The outer surface of the heat exchanger may have an electrical resistivity of at least 400 Ω*cm. The heat exchanger may be a material with a high thermal conductivity and/or a high electrical resistivity, e.g., a material with a thermal conductivity that is equal to or greater than 30 W/m*K and/or an electrical resistivity of at least 400 Ω*cm. The heat exchanger may also be formed from a material with a high thermal conductivity that is coated with a material having a high electrical resistivity or anodized so that the surface of the material in contact with the heating element has a high electrical resistivity.

In some embodiments, the housing may define a filling chamber configured to receive the substance for heating. The filling chamber may be configured to receive air exiting the air flow path at the second end of the heat exchanger. The housing may define an outlet through which the filling chamber is accessible. A temperature sensor may be positioned adjacent the filling chamber. The temperature sensor may be configured to sense a temperature within the filling chamber, as this temperature is indicative of whether the substance in the filling chamber is being vaporized in a desired manner, and the sensed temperature may be utilized to adjust operation of the heating element. The housing may have a container defining the filling chamber. The container may be formed integrally with the heat exchanger. The heat exchanger may be configured to conductively heat the container.

In some embodiments, a second heating element may extend around at least a portion of the filling chamber. The second heating element may be configured to conductively heat the container. The second heating element and/or the heating element may comprise a heater that is wrapped around at least a portion of the outer surface of the container, a ceramic heater, a resistance wire embedded in ceramic, a positive temperature coefficient heater, a negative temperature coefficient heater, a film printed conductor on the outer surface of the container, or a conductive material that is joined to the outer surface of the container, for example, by laser sintering.

In some embodiments, the heat exchanger may be formed from two or more separate components that are joined together.

In some embodiments, the heater assembly may include a sensor configured to measure at least one of a pressure of the air flow path or a mass of air flowing through the air flow path. A microcontroller electrically coupled to the sensor is configured to determine when air is flowing through the air flow path based on a signal from the sensor. The microcontroller may be configured to send electric power to the heating element when it determines that air is flowing through the air flow path.

A heater assembly for a vaporizer in accordance with another aspect of the invention described herein includes a housing with a heat exchanger that extends from a first end to a second end. The heat exchanger defines at least one air flow path that extends through the heat exchanger from the first end to the second end. The housing is configured to retain a substance adjacent the second end for heating. A first electrical lead is connected to a first portion of the heat exchanger and a second electrical lead is connected to a second portion of the heat exchanger. The first and second electrical leads are configured to conduct electric current that flows through the heat exchanger from the first portion to the second portion. The heat exchanger is configured to increase in temperature as the electric current flows through the heat exchanger. The heat exchanger is configured to transfer heat to air flowing through the air flow path from the first end to the second end. The first and second portions of the heat exchanger to which the electrical leads are connected may be adjacent first and second ends of the heat exchanger or first and second sides of the heat exchanger. In some embodiments, the air flow path through the heat exchanger may comprise a plurality of channels extending through the heat exchanger from the first end to the second end.

Additional aspects of the invention, together with the advantages and novel features appurtenant thereto, will be set forth in part in the description which follows, and in part will become apparent to those skilled in the art upon examination of the following, or may be learned from the practice of the invention. The objects and advantages of the invention may be realized and attained by means of the instrumentalities and combinations particularly pointed out in the appended claims.

### BRIEF DESCRIPTION OF THE DRAWINGS

FIG. 1 is a perspective view of a heater assembly in accordance with an exemplary embodiment of the invention described herein;

FIG. 2 is another perspective view of the heater assembly shown in FIG. 1;

FIG. 3 is a perspective view similar to FIG. 1 but with a portion of the heater assembly removed;

FIG. 4 is a top plan view of the heater assembly shown in FIG. 1;

FIG. 5 is a cross-sectional view taken through the line 5-5 shown in FIG. 4;

FIG. 6 is a cross-sectional view taken through the line 6-6 shown in FIG. 4;

FIG. 7 is a perspective view of a heat exchanger and container of the heater assembly shown in FIG. 1;

FIG. 8 is a cross-sectional view of the heat exchanger and container shown in FIG. 7;

FIG. 9 is a cross-sectional view taken through the line 9-9 shown in FIG. 8;

FIG. 10 is a perspective view of an alternative embodiment of heat exchanger and container that may be used with the heater assembly shown in FIG. 1;

FIG. 11 is a side elevational view of the heat exchanger and container shown in FIG. 10;

FIG. 12 is a top plan view of the heat exchanger and container shown in FIG. 10;

FIG. 13 is a cross-sectional view taken through the line 13-13 shown in FIG. 12;

FIG. 14 is a perspective view of an insert of the heat exchanger shown in FIG. 10;

FIG. 15 is a cross-sectional view of an alternative embodiment of heater assembly in accordance with the invention described herein;

FIG. 16 is a schematic diagram showing connections between certain components of the heater assembly shown in FIG. 1 and a microcontroller;

FIG. 17 is a cross-sectional view of another alternative embodiment of heater assembly in accordance with the invention described herein;

FIGS. 18A and 18B are perspective views of a heat exchanger and container that may be used with any of the heater assemblies described herein;

FIGS. 19A and 19B are perspective views of another heat exchanger and container that may be used with any of the heater assemblies described herein; and

FIG. 20 is a sectional, perspective view of a further heat exchanger and container that may be used with any of the heater assemblies described herein.

### DETAILED DESCRIPTION OF EXEMPLARY EMBODIMENTS

A heater assembly for a vaporizer in accordance with an embodiment of the invention described herein is identified generally as 10 in FIGS. 1-4. As described in more detail below, the heater assembly 10 may be configured to quickly and efficiently heat a substance for vaporization. The heater assembly 10 may further heat such substance relatively uniformly so that portions of the substance are not overheated while other portions of the substance remain under heated. The heater assembly 10 may also have a relatively small size or form factor allowing it to be integrated into a vaporizer that is relatively small. The heater assembly 10 may be used in any type of vaporizer, including a handheld vaporizer or a desktop vaporizer. The heater assembly 10 may be configured to heat a substance so that compounds of the substance are vaporized for inhalation by a user.

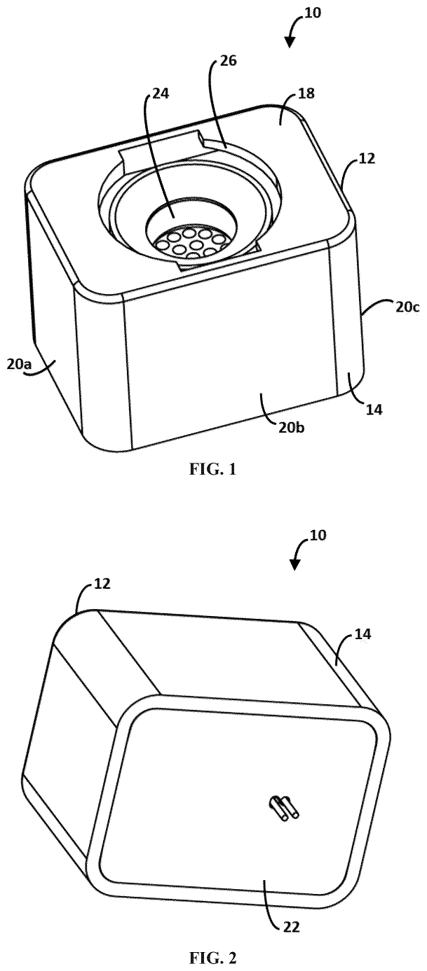

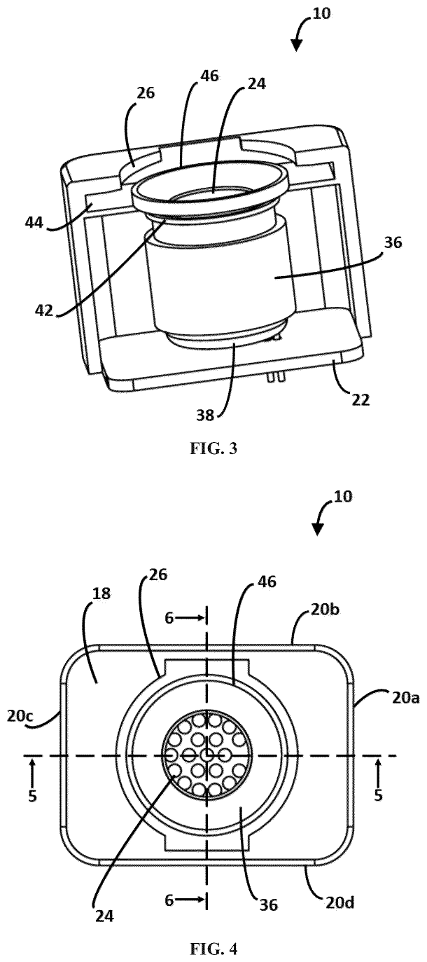

Referring to FIG. 1, the heater assembly 10 includes a housing 12 with an outer shell 14 that is generally shaped like a cuboid in the embodiment shown in FIG. 1, although the outer shell 14 may have any suitable shape. The outer shell 14 includes a top wall 18, side walls 20a-d (FIG. 4), and a base 22 (FIG. 2). A filling chamber 24 of the housing 12 is accessible through an opening 26 in the top wall 18. The filling chamber 24 is configured to receive a substance for heating and subsequent vaporization of compounds of the substance. The outer shell 14 may include one or more openings (not shown) in any of the top wall 18, side walls 20a-d, or base 22 to allow air to enter the outer shell 14, as described in more detail below.

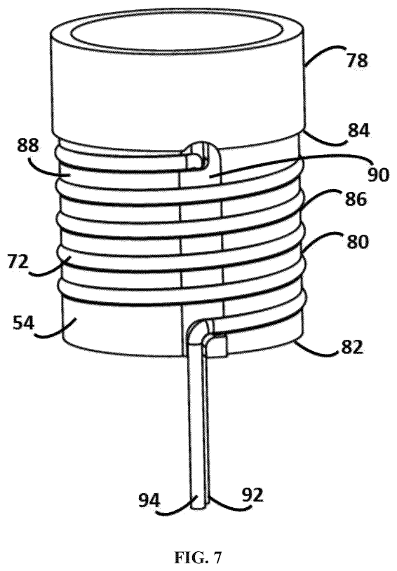

Referring to FIG. 3, half of the outer shell 14 is not shown so that internal details of the heater assembly 10 are visible. An outer shroud 36 is positioned within the outer shell 14. As described in more detail below, the outer shroud 36 is positioned around an inner shroud 38, a heat exchanger 54 (FIG. 7), and a container 78 (FIG. 7) of the heater assembly 10. A groove 42 extending around the outer shroud 36 receives an intermediate wall 44 of the outer shell 14 to position the outer shroud 36 with respect to the outer shell 14. An upper portion of the outer shroud 36 extends above the intermediate wall 44 and defines an opening or outlet 46 that is generally aligned with the opening 26 in the top wall 18. The filling chamber 24 is accessible through the outlet 46.

FIG. 4 shows the top wall 18 of the heater assembly 10 showing the filling chamber 24 accessible through the opening 26 in the top wall 18 and the outlet 46 of the outer shroud 36.

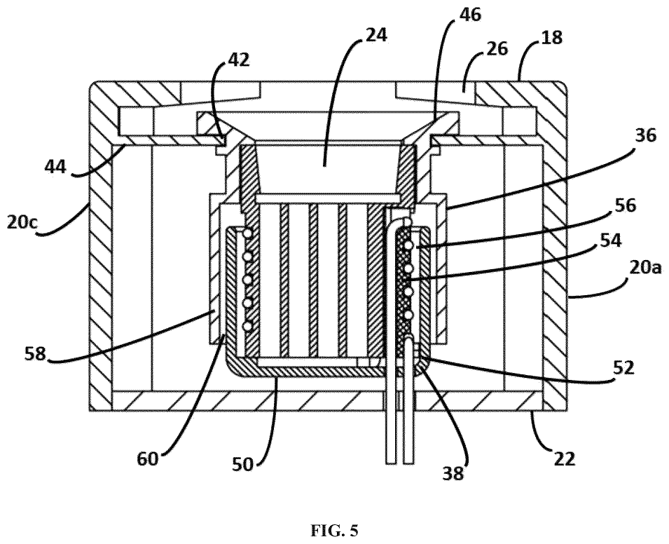

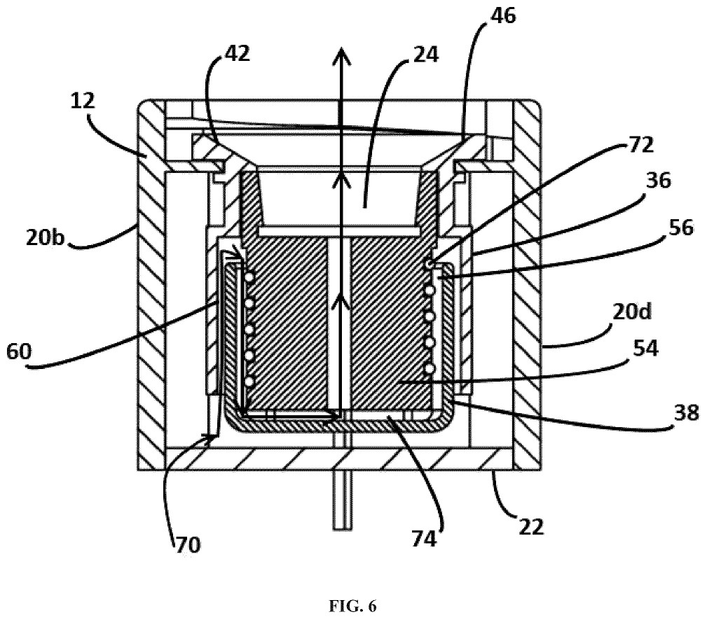

Referring to FIG. 5, a cross-sectional view of the heater assembly 10, the inner shroud 38 has a bottom wall 50 and a generally cylindrical side wall 52 that define a receptacle receiving a heat exchanger 54, which is described below in connection with FIGS. 7-9. The heat exchanger 54 is radially spaced inward from the side wall 52 of the inner shroud 38 to define an annular gap 56 between the heat exchanger 54 and side wall 52. As described above, the outer shroud 36 is mounted to the intermediate wall 44. The outer shroud 36 has a generally cylindrical side wall 58 extending downward from the intermediate wall 44 toward the base 22. The inner shroud 38 is radially spaced inward from the outer shroud 36 to define an annular gap 60 between the inner shroud 38 and outer shroud 36.

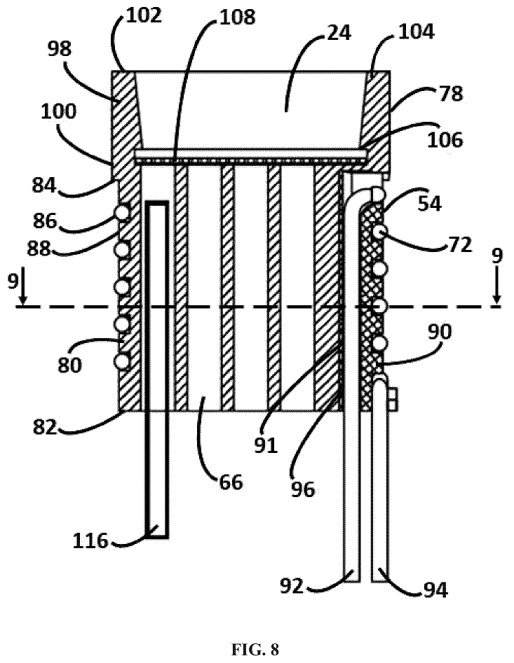

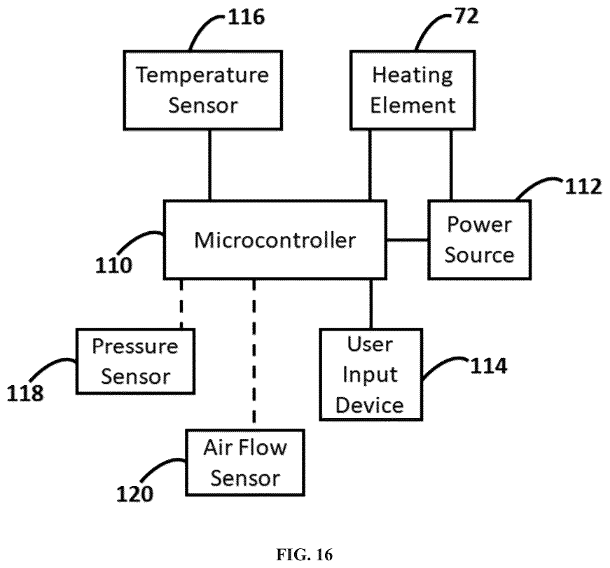

A temperature sensor 116 (FIG. 16) may be positioned in or near the heat exchanger 54. As described in more detail below, the heat exchanger 54 has a plurality of channels, one of which is identified as 66, extending axially through the heat exchanger 54 from adjacent the inner shroud 38 to adjacent the filling chamber 24. The temperature sensor 116 may be positioned in one of the channels 66 adjacent the filling chamber 24 (e.g., as shown in FIG. 8) so that it can sense a temperature within the filling chamber 24 or an area adjacent the filling chamber 24. As described below, the temperature sensed by the temperature sensor 116 may be used to control when a heating element of the heater assembly 10 is powered by a power source. The temperature sensor 116 may be, for example, a type-K thermocouple, a negative temperature coefficient thermistor (NTC), or a platinum measuring resistor (PT100/PT1000).

FIG. 6 shows an air flow path 70 through the housing 12 when air is drawn through outlet 46 to vaporize a substance. The air enters the housing 12 through one or more of the openings (not shown) in the outer shell 14 and/or through gaps between different portions of the outer shell 14, e.g., through a gap between the base 22 and side walls 20a-d. The air enters the space between the outer shell 14 and the outer shroud 36, and then flows around a lower edge of the outer shroud 36 into the annular gap 60 between the outer shroud 36 and the inner shroud 38. The air flows upward through the annular gap 60 and around an upper edge of the inner shroud 38. The air flow path 70 makes a 180 degree turn at the upper edge of the inner shroud 38 and then flows downward through the annular gap 56 between the inner shroud 38 and the heat exchanger 54. A heating element 72 is wound around an outer surface of the heat exchanger 54, as described in more detail below with reference to FIGS. 7-9. The heating element 72 heats the air as it flows downward through the annular gap 56. The air flow path 70 extends downward along the length of the heat exchanger 54 until it reaches the bottom of the heat exchanger 54. The air flow path 70 then extends radially inward through a space 74 between the bottom of the heat exchanger 54 and the bottom wall 50 of the inner shroud 38. The air flow path 70 then turns 90 degrees upward through the plurality of channels 66 extending through the heat exchanger 54. The plurality of channels 66 define a plurality of air flow paths 70 through the heat exchanger 54. The heat exchanger 54 is heated by the heating element 72, and as the air flows adjacent to and through the heat exchanger 54, the air is heated by the heat exchanger 54. At the top of the heat exchanger 54, the air flow path 70 exits the heat exchanger 54 and enters the filling chamber 24. As the air flows through the filling chamber 24, it convectively heats a substance positioned in the filling chamber 24. The air and any vaporized compounds of the substance travel upward from the filling chamber 24 and through the outlet 46. While not shown in the drawings, an inhalation structure (e.g., a housing with a tube or mouthpiece) may be joined to the top wall 18 for receiving air and vaporized portions of the substance exiting the outlet 46 and routing the air and vaporized portions of the substance into a user's mouth or storage device (e.g., a bag). The air flow path 70 described above and shown in FIG. 6 is exemplary only. The heater assembly 10 may be structured so that the air flowing through the housing takes a different path as it is heated by the heat exchanger 54. Further, the directional terms (e.g., “upward” and “downward”) used herein describe the exemplary air flow path 70 when the heater assembly 10 is in the orientation shown in FIG. 6. When the heater assembly 10 is positioned in a different orientation, the direction of the air flow path may be different from what is described herein.

The heat exchanger 54 and a container 78 of the housing 12 are described below making reference to FIGS. 7-9. The heat exchanger 54 and container 78 are shown as being integral with each other. In alternative embodiments, however, the container 78 may be formed separately from the heat exchanger 54 and positioned on top of the heat exchanger 54 within the outer shroud 36 (FIG. 5). The heat exchanger 54 has an outer wall 80 that extends from a first end 82 to a second end 84 of the heat exchanger 54. The outer wall 80 is generally cylindrical and defines, at least in part, the channels 66 (and associated air flow path 70) extending axially through the heat exchanger 54. A helical groove 86 extends around the outer wall 80 from adjacent the first end 82 to adjacent the second end 84. The heating element 72 is positioned in the helical groove 86. The heat exchanger 54 and container 78 may, for example, be milled from a single block of material. The heat exchanger 54 may also include an insert, similar to that described below for the embodiment shown in FIGS. 10-14, that is positioned within the outer wall 80 to define the channels 66. The channels 66 may be drilled holes extending through the heat exchanger 54 with the outer wall 80 generally extending around the holes.

The heat exchanger 54 may be formed from a material with a relatively high thermal conductivity so that heat from the heating element 72 is readily conducted through the material to the surfaces surrounding the channels 66 and the air flowing through the channels 66. For example, the heat exchanger 54 may be formed from a metal, such as aluminum or titanium, or any other suitable material including a ceramic material, such as magnesium dioxide or zirconium dioxide. The heat exchanger 54 may be formed from a material with a thermal conductivity that is equal to or greater than approximately 1 W/m*K, and in some embodiments equal to or greater than 30 W/m*K.

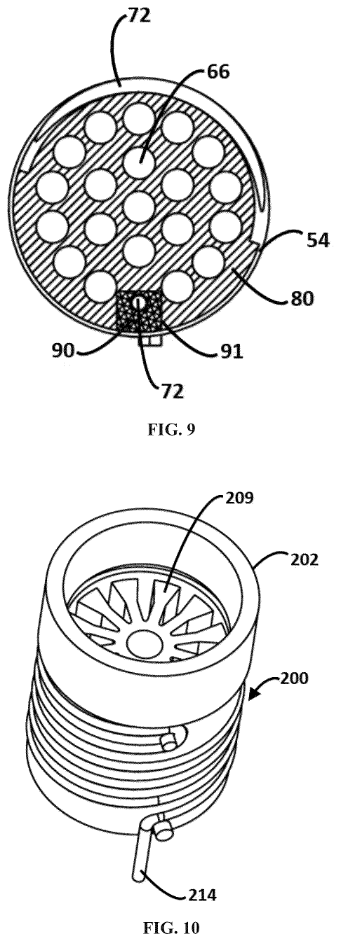

The combined surface area of the surfaces surrounding the channels 66 through the heat exchanger 54 enhances the ability of heat exchanger 54 to transfer heat to the air flowing through the air flow path 70. For example, FIG. 9 shows approximately 20 separate channels 66 extending through the heat exchanger 54. Each of these channels 66 forms a part of the air flow path 70 of the air flowing through the heat exchanger 54. The surfaces of the heat exchanger 54 surrounding each of these channels 66 are heated as heat is transferred from the heating element 72 through the heat exchanger 54 to the surfaces. The heated surfaces surrounding each of the channels 66 heat the air as it flows through the channels 66. By having a plurality of channels 66, the surface area of the heat exchanger 54 that is adjacent the air flow path 70 is relatively large and therefore able to transfer heat to the air flowing through the air flow path 70 relatively quickly and efficiently. Providing the channels 66 may transfer heat to the air flowing through the heat exchanger 54 at a greater rate than, for example, a heat exchanger with an air flow path that includes only one channel. Further, the channels 66 allow the heat exchanger 54 to have a relatively small size or profile while still heating the air flowing through it relatively quickly and efficiently. For example, the heat exchanger 54 may transfer heat to the air flowing through it at the same rate as a typical heat exchanger much larger in size. The heat exchanger 54 may also require less energy to heat an airflow to a specific temperature than a typical heat exchanger.

The outer surface 88 of the heat exchanger 54, including the surfaces defining the groove 86, may have a relatively high electrical resistivity. For example, an electrical resistivity of between approximately 10⁸ to 10¹⁰ Ω*cm, or at least 400 Ω*cm. In particular, if the heating element 72 is a resistance wire that conducts electricity, at least the portions of the outer surface 88 that contact the heating element 72 may have a relatively high electrical resistivity so that electric current from the heating element 72 is not appreciably conducted through the heat exchanger 54 and container 78. For example, if the heat exchanger 54 is formed from aluminum, the outer surface 88 may be anodized. The outer surface 88 may also be coated with a material that has a relatively high electrical resistivity such as a ceramic material or a tape formed from polyimide film with a silicon adhesive, including Kapton® tape.

The heating element 72 is a resistance wire heating element that, as described above, is wrapped around the outer wall 80 and positioned in the helical groove 86. The heating element 72 extends around the channels 66 extending through the heat exchanger 54 with portions of the heat exchanger 54 positioned between the heating element 72 and the channels 66. The heat exchanger 54 includes an insert 90 that is positioned within an axial groove 91 (FIGS. 8-9) extending from the first end 82 to the second end 84. The insert 90 is designed to minimize short circuits at locations where the heating element 72 bends around edges of the heat exchanger 54 as it is routed around and through the heat exchanger 54. If the outer surface 88 of the heat exchanger 54 is anodized, the anodized surface at the edges may be susceptible to damage and loss of electrical isolation. Thus, the insert 90 may be formed from a ceramic material with a high electrical resistivity that reduces the likelihood that the heating element 72 will short circuit through the heat exchanger 54. In some embodiments, the heating element 72 may be embedded within the outer wall 80 of the heat exchanger 54 such that the heating element 72 extends around the channels 66. In some embodiments, the heating element 72 may be any type of heating element that is configured to wrap around at least a portion of the heat exchanger 54, including a flexible printed heater, a ceramic heater, a resistance wire embedded in ceramic, a positive temperature coefficient heater, a negative temperature coefficient heater, a film printed conductor on the outer surface 88 of the heat exchanger 54, or a conductive material that is joined to the outer surface 88 of the heat exchanger 54, for example, by laser sintering.

Referring to FIGS. 7 and 8, the heating element 72 has a first end 92 and a second end 94. The heating element 72 extends from the first end 92 through a channel 96 (FIG. 8) in the insert 90 upward toward the second end 84 of the heat exchanger 54. The heating element 72 exits the channel 96 and bends 90 degrees toward the outer surface 88 of the heat exchanger 54. As shown in FIG. 7, the heating element 72 then travels through the groove 86 around the outer wall 80 in a helical manner from the second end 84 of the heat exchanger 54 toward the first end 82 of the heat exchanger 54. The heating element 72 then exits the groove 86 at the insert 90 and wraps around a portion of the insert 90 before terminating at the second end 94 of the heating element 72. The heating element 72 may take other paths around the heat exchanger 54, including that path described below in connection with the embodiment shown in FIGS. 10-14. For example, the heating element may be structured so that it includes a series of spaced apart rings extending around the outer surface of the heat exchanger. Each of the rings may be connected to adjacent rings via a segment of wire extending between adjacent rings.

The container 78 is formed integrally with the heat exchanger 54 and extends upwardly from the heat exchanger 54. As shown in FIG. 8, the container 78 has an outer wall 98 extending upwardly from the outer wall 80 of the heat exchanger 54. The container 78 has a first end 100 at the second end 84 of the heat exchanger 54 and a second end 102. An outlet 104 of the container 78 is at the second end 102. The outlet 104 is aligned with the outlet 46 of the outer shroud 36 (FIG. 5). At the first end 100 of the container 78, the inner surface of the outer wall 98 defines a groove 106. The groove 106 may receive, for example, a screen 108 that supports a substance within the filling chamber 24 above the heat exchanger 54 and generally prevents the substance from entering the heat exchanger 54. The container 78 defines the filling chamber 24 that is positioned above the heat exchanger 54, with the filling chamber 24 being sized and configured to retain a substance for vaporization, as described above. The filling chamber 24 is positioned above the channels 66 in the heat exchanger 54 so that heated air from the heat exchanger 54 flows upward through the filling chamber 24 when air is drawn through the heater assembly 10. The channels 66 are generally spaced homogeneous apart across the width of the filling chamber 24 to promote generally uniform heating of the substance in the filling chamber 24.

When the heat exchanger 54 is heated by the heating element 72, the heat exchanger 54 conductively heats the container 78, and the container 78 heats the substance positioned within the filling chamber 24 via conduction (for material positioned in contact with the inner surface of the container 78) and via radiation (for material spaced apart from the inner surface of the container 78). If the heat exchanger 54 and the container 78 are formed separately, they may abut so that heat is conducted from the heat exchanger 54 to the container 78. If the heating element 72 is powered to heat the heat exchanger 54 prior to air being drawn or pumped through the heat exchanger 54, the substance within the filling chamber 24 may be preheated by the conductive and radiative heat transfer described above to a desired temperature that is near or at the vaporization temperature of compounds within the substance desired for vaporization. Such substance may then be convectively heated by the heated air flowing through the heat exchanger 54 and the filling chamber 24, as described above. The combination of the conductive and radiative preheating of the substance and the convective heating of the substance when air is drawn through the filling chamber 24 may improve the experience of using a vaporizer incorporating the heater assembly 10 by (1) heating the substance relatively quickly via the conductive and radiative preheating so that the user does not need to wait long to use the vaporizer, and (2) heating the substance in a relatively uniform manner to a desired temperature via the convective heating so that significant portions of the substance are not overheated above a desired temperature while other portions are under heated.

A microcontroller 110, shown in FIG. 16, may be configured to send electric power from a power source 112 to the heating element 72. The power source 112 may be, for example, a battery or mains power. The microcontroller 110 may receive instructions from a user input device 114, for example a touchscreen display panel or regular buttons, associated with the heater assembly 10. The microcontroller 110 may also receive instructions wirelessly from a mobile device or computer. The microcontroller 110 may be programmed to cause the heating element 72 to be powered at desired times so that it reaches a desired temperature based on the instructions received. The microcontroller 110 may also receive temperature readings from a temperature sensor 116 and use such temperature readings to determine when, and for how long, to power the heating element 72. It may be desired to power the heating element 72 as air is drawn through the heater assembly 10 so that the air is heated to a desired temperature by the heat exchanger 54. The microcontroller 110 may also be configured to monitor a resistance of the heating element 72 and determine when air is flowing through the air flow path 70 by changes in such resistance. The determination of when air is flowing through the air flow path may further be used to determine when to power the heating element 72. A pressure sensor 118 or an air flow sensor 120 may also be used to determine when air is flowing through the air flow path 70. The microcontroller 110 may receive a signal from the pressure sensor 118 or air flow sensor 120. For example, when air is drawn through the heater assembly 10 by a user, the pressure sensor 118 may detect a pressure differential or the air flow sensor 120 may detect a mass of air flowing through the air flow path 70. The microcontroller 110 may use the pressure differential or air mass measurement to determine whether to power the heating element 72.

The heater assembly 10 may be used with a vaporizer that is configured to have a user draw air through the heat exchanger 54 and filling chamber 24 by drawing air through a tube, mouthpiece, or other device connected to the top wall 18. The heater assembly 10 may also be used with a vaporizer having an air pump that is configured to pump air through the heat exchanger 54 and filling chamber 24. The heater assembly 10 may be configured so that a storage device is mounted above the filling chamber 24 with the storage device capable of receiving air and vaporized portions of the substance as the air pump operates. The heater assembly 10 may further be used with a vaporizer that is user-configurable for use in connection with either pumping air through the heat exchanger 54 or having air passively drawn through the heat exchanger 54 by a user drawing air through the outlet 46.

An alternative embodiment of heat exchanger 200 and container 202 that may be used with the heater assembly 10 is described with reference to FIGS. 10-14. As shown in FIG. 11, the heat exchanger 200 has an outer wall 204 extending from a first end 206 to a second end 208. The heat exchanger 200 has an insert 209 (FIG. 10) positioned in a chamber defined by the outer wall 204. The outer wall 204 of the heat exchanger 200 has two helical grooves 210, 212 (FIG. 11) extending from the first end 206 to the second end 208. The helical grooves 210, 212 receive a heating element 214 that may operate in a similar manner as the heating element 72 described above. The outer wall 204 and insert 209 of the heat exchanger 200 may be made from any of the materials described above for heat exchanger 54, and the outer surface of the outer wall 204 may be anodized or coated with a material having a high electrical resistivity, as described above in connection with heat exchanger 54.

The heating element 214 has a first end 216 and a second end 218, shown in FIG. 11. The heating element 214 extends from the first end 216 around a post 220 and into the second groove 212. The heating element 214 wraps around the outer wall 204 within the second groove 212 from the first end 206 to the second end 208. At the second end 208, the heating element 214 exits the second groove 212 and wraps 180 degrees around a post 222. From the post 222, the heating element 214 enters the first groove 210 and wraps around the outer wall 204 within the first groove 210 toward the first end 206. At the first end 206, the heating element 214 wraps around a post (not shown) similar to post 220 and terminates at its second end 218.

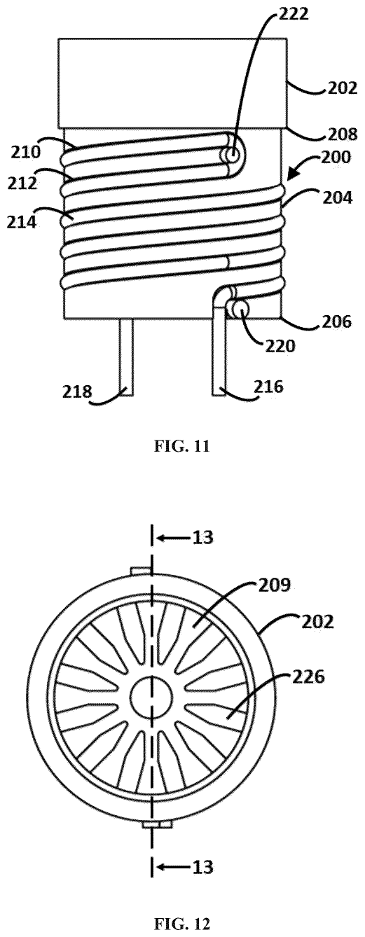

FIG. 12 shows a plurality of channels 226 extending through the insert 209. The channels 226 form an air flow path through the heat exchanger 200 in a similar manner as the channels 66 described above. The channels 226 further function to increase the surface area of the heat exchanger 200 that is exposed to the air flowing through it in order to efficiently transfer heat to the air, as described above in more detail with respect to heat exchanger 54.

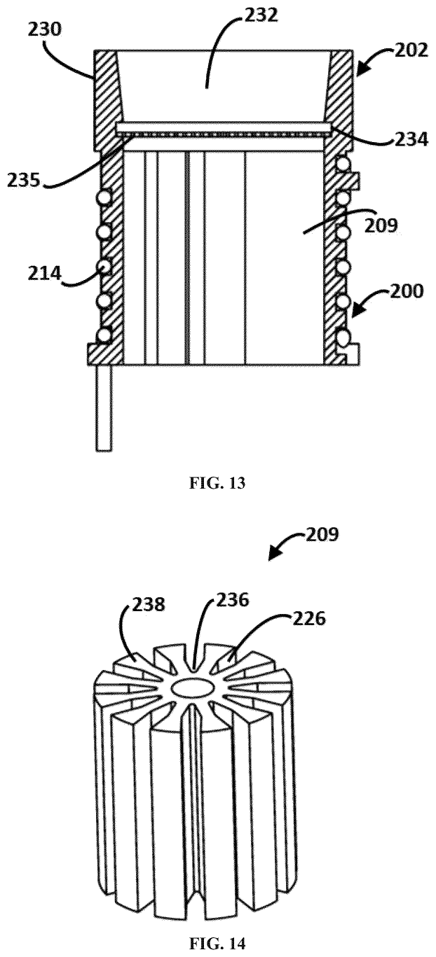

FIG. 13 shows that the container 202 is formed integrally with the heat exchanger 200 and has an outer wall 230 extending upwardly from the heat exchanger 200. The container 202 defines a filling chamber 232 configured to receive a substance in a similar manner as the container 78 described above. A groove 234 formed in an inner surface of the outer wall 230 receives a screen 235 to support a substance within the filling chamber 232 above the insert 209.

Referring to FIG. 14, the insert 209 has a central hub 236 with a plurality of spokes 238 radially extending outward from the hub 236. The spokes 238 are generally spaced equidistant from each other circumferentially to create the channels 226. The heat exchanger 200 may be manufactured from two or more separate components. For example, the outer wall 204 may be manufactured from one component, and the insert 209 manufactured from a separate component. After the outer wall 204 and insert 209 are manufactured, they may be joined to form the heat exchanger 200, as shown in FIG. 10. Manufacturing the outer wall 204 and insert 209 from separate components may simplify manufacturing of the heat exchanger and lower manufacturing costs. Other than as described herein, the heat exchanger 200 and container 202 may be structured and function in substantially the same manner as the heat exchanger 54 and container 78 described above.

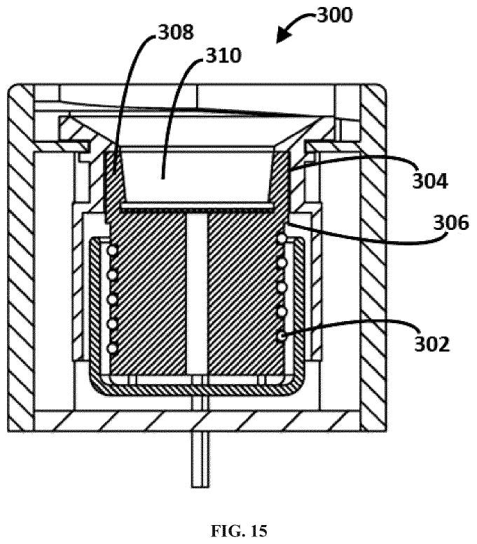

Referring now to FIG. 15, another alternative embodiment of heater assembly is identified generally as 300. Heater assembly 300 is substantially similar to heater assembly 10 described above except as described herein. The difference between heater assembly 300 and heater assembly 10 is that heater assembly 300 includes two heating elements, a first heating element 302 that is substantially similar to the heating element 72 of heater assembly 10, and a second heating element 304. The second heating element 304 is wrapped around at least a portion of, or all of, an outer surface 306 of a container 308, and a filling chamber 310 defined by the container 308. The container 308 is substantially similar to the container 78 described above except for the second heating element 304. The second heating element 304 may be used to conductively heat the container 308, which transfers the heat via conduction and radiation to a substance within the filling chamber 310. The second heating element 304 may be used to preheat the substance within the filling chamber 310 prior to a user drawing air through the heater assembly 300, in a similar manner as described above with respect to conductive and radiative heating of the substance within the filling chamber 24 described above. A microcontroller (not shown) of the heater assembly 300 may be programmed to power the first and second heating elements 302 and 304 individually to heat the substance to a desired temperature within a desired timeframe and to maintain such temperature for a desired length of time. Temperature readings from one or more temperature sensors, like the sensor 116 described above, may be used by the microcontroller to determine when to power the first and second heating elements 302 and 304.

The second heating element 304 may be any type of heating element configured to wrap around at least a portion of the container 308, including a flexible printed heater, a ceramic heater, a resistance wire embedded in ceramic, a positive temperature coefficient heater, a negative temperature coefficient heater, a film printed conductor on the outer surface 306 of the container 308, or a conductive material that is joined to the outer surface 306 of the container 308, for example, by laser sintering.

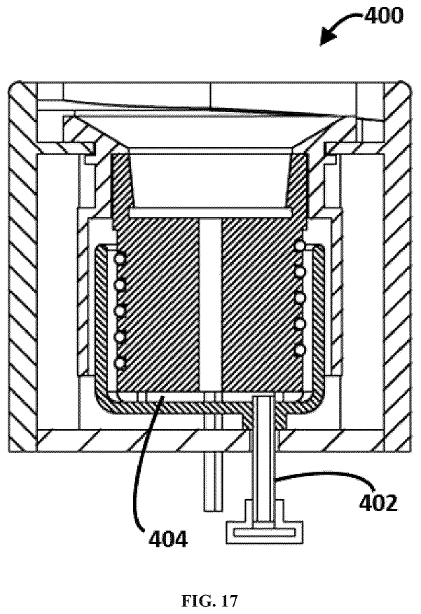

FIG. 17 shows an alternative embodiment of heater assembly 400, which is substantially the same as the heater assembly 10, except that the heater assembly 400 includes a sensor 402 in fluid communication with an air flow path 404 through the heater assembly 400. The sensor 402 may be (1) a differential pressure sensor that is configured to measure the gauge pressure of the air flow path 404, or the difference in pressure between the air flow path 404 and the ambient air surrounding the heater assembly 400, (2) an absolute pressure sensor that is configured to measure the absolute pressure of the air within the air flow path 404, or (3) an air flow sensor that is configured to measure a mass of air flowing in the air flow path 404 within a particular time frame. The pressure sensor 118 and air flow sensor 120 described above and shown in FIG. 16 may be configured in the same manner as the sensor 402 shown in FIG. 17. The sensor 402 may be configured to sense when air is flowing through the air flow path 404, as described above in connection with FIG. 16, and send a signal to the microcontroller, which may determine when air is flowing through the air flow path 404 and whether to power the heating element based on the signal.

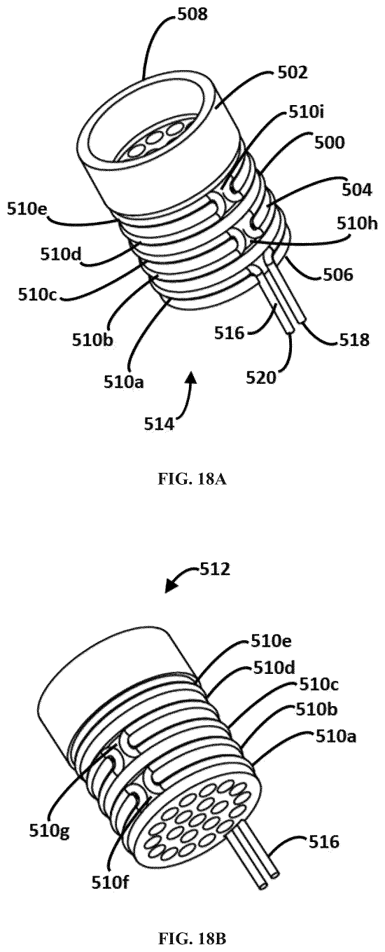

FIGS. 18A and 18B show an alternative embodiment of heat exchanger 500 and container 502 that may be used with any of the heater assemblies 10, 300, or 400 described herein. The heat exchanger 500 has an outer wall 504 extending from a first end 506 to a second end 508. The outer wall 504 of the heat exchanger 500 has a series of spaced apart grooves 510a-e extending around the outer wall 504. The grooves 510a-b are connected on a first side 512 of the heat exchanger 500, as shown in FIG. 18B, via a groove 510f. The grooves 510c-d are also connected on the first side of the heat exchanger 500 via a groove 510g. The grooves 510b-c are connected on a second side 514 of the heat exchanger 500 via a groove 510h, and the grooves 510d-e are connected on the second side 514 via a groove 510i. The grooves 510a-i receive a heating element 516 that may operate in a similar manner as the heating element 72 described above. The outer wall 504 may be made from any of the materials described above for heat exchanger 54, and the outer surface of the outer wall 504 may be anodized or coated with a material having a high electrical resistivity, as described above in connection with heat exchanger 54.

The heating element 516 has a first end 518 and a second end 520 shown in FIG. 18A. The heating element 516 extends from the first end 518 into the groove 510a and around the outer wall 504 from the second side 514 to the first side 512. The heating element 516 extends from the groove 510a through the groove 510f and into the groove 510b making a 180 degree turn back toward the second side 514. The heating element 516 continues on a similar path through the grooves 510h, 510c, 510g, 510d, and 510i on one side of the heat exchanger 500 toward the second end 508. The heating element 516 then enters the groove 510e and extends substantially around the perimeter of the outer wall 504 to the groove 510i. The heating element 516 then extends through the grooves 510d, 510g, 510c, 510h, 510b, 510f, and 510a on the opposite side of the heat exchanger before terminating at its second end 520. Other than as described herein, the heat exchanger 500 and container 502 may be structured and function in substantially the same manner as the heat exchanger 54 and container 78 described above.

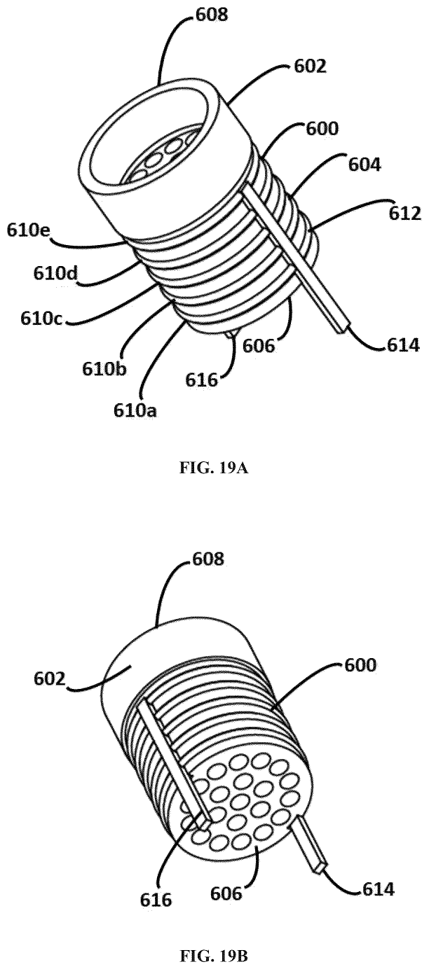

FIGS. 19A and 19B show another alternative embodiment of heat exchanger 600 and container 602 that may be used with any of the heater assemblies 10, 300, or 400 described herein. The heat exchanger 600 has an outer wall 604 extending from a first end 606 to a second end 608. The outer wall 604 of the heat exchanger 600 has a series of spaced apart grooves 610a-e extending around the outer wall 604. Each of the grooves 610a-e receives a heating element, one of which is identified as 612. The heating elements 612 received in the grooves 610a-e are a series of spaced apart rings each wrapped around the outer wall 604. The heating elements 612 may operate in a similar manner as the heating element 72 described above. The outer wall 604 may be made from any of the materials described above for heat exchanger 54, and the outer surface of the outer wall 604 may be anodized or coated with a material having a high electrical resistivity, as described above in connection with heat exchanger 54.

A first electrical lead 614 extends from the first end 606 toward the second end 608 on one side of the heat exchanger 600. The first electrical lead 614 may be positioned within a groove formed in the outer wall 604 that extends transverse to the grooves 610a-e. The first electrical lead 614 is electrically connected with each of the heating elements 612. A second electrical lead 616, best shown in FIG. 19B, also extends from the first end 606 toward the second end 608. The second electrical lead 616 may also be positioned within a groove formed in the outer wall 604 that extends transverse to the grooves 610a-e. The second electrical lead 616 is electrically connected with each of the heating elements 612 on an opposite side of the heat exchanger 600 as the first electrical lead 614. A voltage may be applied across the first and second electrical leads 614 and 616 causing electrical current to flow through each of the heating elements 612, which generate heat that is transferred to the heat exchanger 600 in a similar manner as described above with respect to heat exchanger 54. Other than as described herein, the heat exchanger 600 and container 602 may be structured and function in substantially the same manner as the heat exchanger 54 and container 78 described above.

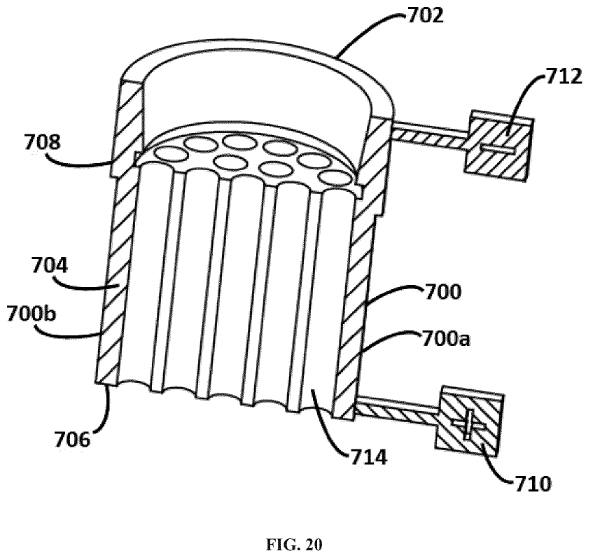

Referring to FIG. 20, another alternative embodiment of heat exchanger 700 and container 702 is shown that may be used with any of the heater assemblies 10, 300, or 400 described herein. The heat exchanger 700 has an outer wall 704 extending from a first end 706 to a second end 708. A first electrical lead 710 is connected to the outer wall 704 at the first end 706, and a second electrical lead 712 is connected to the outer wall 704 at the second end 708. The first and second electrical leads 710 and 712 are configured to conduct electric current that flows through the heat exchanger 700 from the first end 706 to the second end 708 when a voltage is applied to the leads. The heat exchanger 700 is made from a material with a relatively high electrical resistivity that causes it to increase in temperature as the electric current flows through it from the first end 706 to the second end 708. The heat exchanger 700 further is made from a material with a relatively high thermal conductivity so that the heat generated by the electric current is conducted throughout the heat exchanger, and in particular to the surfaces surrounding the channels 714 extending through the heat exchanger. As described above in connection with the heat exchanger 54, the heated surfaces surrounding the channels 714 transfer heat to air flowing through the channels from the first end 706 to the second end 708. The heat exchanger 700 also transfers heat to the container 702 to conductively heat a material within the container 702. While the first and second electrical leads 710 and 712 are shown at first and second ends 706 and 708 of the heat exchanger, respectively, instead of being at opposite ends of the heat exchanger, the first and second electrical leads 710 and 712 may be on opposite sides of the heat exchanger. For example, the first electrical lead 710 may be positioned on the right side 700a of the heat exchanger 700 as shown in FIG. 20, and the second electrical lead 712 may be positioned on the left side 700b as shown in FIG. 20. The first and second electrical leads 710 and 712 may further be positioned on opposite sides and ends of the heat exchanger. For example, the first electrical lead 710 may be positioned as shown in FIG. 20, and the second electrical lead 712 may be positioned on the left side 700b as shown in FIG. 20 at the second end 708. The heat exchanger 700 may be made from any suitable material, which may include nichrome or graphite. Other than as described herein, the heat exchanger 700 and container 702 may be structured and function in substantially the same manner as the heat exchanger 54 and container 78 described above.

The heater assembly 10 may be used with any type of vaporizer, including handheld or desktop vaporizers. According to one exemplary method of using the heater assembly 10, a substance is placed in the filling chamber 24 and the microcontroller 110 receives instructions to heat the substance to a desired temperature. The microcontroller 110 causes the heating element 72 to be powered by the power source 112. The heating element 72 heats the heat exchanger 54, container 78, and substance via conduction and radiation in the manner described above. When the temperature sensor 116 senses that a desired preheating temperature is reached at or adjacent the filling chamber 24 or a given amount of time has elapsed, the microcontroller 110 may cause the vaporizer to indicate to a user that the vaporizer is ready for use. The user may draw air and the vaporized substance through an inhalation structure (not shown) that is attached to the top of the heater assembly 10. As the user draws air through the heat exchanger 54, the air is heated as described above to convectively heat the substance as the air flows through the filling chamber 24.

The heater assembly 300 may be used in a substantially similar manner as the heater assembly 10 with the second heating element 304 of the heater assembly 300 being used to preheat the substance within the filling chamber 310.

From the foregoing it will be seen that this invention is one well adapted to attain all ends and objectives herein-above set forth, together with the other advantages which are obvious and which are inherent to the invention.

Since many possible embodiments may be made of the invention without departing from the scope thereof, it is to be understood that all matters herein set forth or shown in the accompanying drawings are to be interpreted as illustrative, and not in a limiting sense.

While specific embodiments have been shown and discussed, various modifications may of course be made, and the invention is not limited to the specific forms or arrangement of parts and steps described herein, except insofar as such limitations are included in the following claims. Further, it will be understood that certain features and subcombinations are of utility and may be employed without reference to other features and subcombinations. This is contemplated by and is within the scope of the claims.

What is claimed and desired to be secured by Letters Patent is as follows:

1. A heater assembly for a vaporizer, comprising:
a housing comprising a heat exchanger that extends from a first end to a second end, the heat exchanger defining at least one air flow path that extends through the heat exchanger from the first end to the second end, and the housing configured to retain a substance adjacent the second end for heating; and
a heating element extending around at least a portion of the air flow path with a portion of the heat exchanger positioned between the heating element and the air flow path, wherein the heating element is configured to heat the heat exchanger, and wherein the heat exchanger is configured to transfer heat from the heating element to air flowing through the air flow path from the first end to the second end.

2. The heater assembly of claim 1, wherein the heating element comprises a resistance wire that is wrapped around at least a portion of an outer wall of the heat exchanger.

3. The heater assembly of claim 2, wherein the heat exchanger comprises an electrically non-conductive insert coupled to the outer wall, and wherein the resistance wire engages the insert at a location where the resistance wire changes direction.

4. The heater assembly of claim 3, wherein the resistance wire comprises a first end and a second end, the resistance wire extending from the first end through a channel in the insert toward the second end of the heat exchanger, the wire extending from the channel around the outer wall in a helical manner toward the first end of the heat exchanger and the second end of the wire.

5. The heater assembly of claim 3, wherein the insert comprises a ceramic material.

6. The heater assembly of claim 2, further comprising a microcontroller configured to monitor a resistance of the resistance wire, the microcontroller configured to determine when air is flowing through the air flow path based on changes in the resistance.

7. The heater assembly of claim 2, wherein the resistance wire comprises a series of spaced apart rings each wrapped around at least a portion of the outer wall of the heat exchanger, wherein each ring is connected to a first electrical lead and a second electrical lead.

8. The heater assembly of claim 2, wherein the resistance wire comprises a first end and a second end, the resistance wire extending from the first end around a portion of the outer wall on one side of the heat exchanger toward the second end of the heat exchanger and then around a portion of the outer wall on an opposite side of the heat exchanger toward the first end of the heat exchanger and the second end of the wire.

9. The heater assembly of claim 1, wherein the air flow path through the heat exchanger comprises a plurality of channels extending through the heat exchanger from the first end to the second end, and wherein the heating element extends around at least a portion of each of the channels with a portion of the heat exchanger positioned between the heating element and each of the channels.

10. The heater assembly of claim 1, wherein the heat exchanger has a thermal conductivity that is equal to or greater than 30 W/m*K.

11. The heater assembly of claim 1, wherein an outer surface of the heat exchanger has an electrical resistivity of at least 400 Ω*cm.

12. The heater assembly of claim 1, wherein an outer surface of the heat exchanger comprises at least one of anodized aluminum or ceramic.

13. The heater assembly of claim 1, wherein the housing defines a filling chamber configured to receive the substance for heating, and wherein the filling chamber is configured to receive air exiting the air flow path at the second end of the heat exchanger.

14. The heater assembly of claim 13, wherein the housing defines an outlet through which the filling chamber is accessible.

15. The heater assembly of claim 13, further comprising a temperature sensor positioned adjacent the filling chamber.

16. The heater assembly of claim 13, wherein the housing comprises a container defining the filling chamber.

17. The heater assembly of claim 16, wherein the container is formed integrally with the heat exchanger.

18. The heater assembly of claim 16, wherein the heat exchanger is configured to conductively heat the container.

19. The heater assembly of claim 16, further comprising a second heating element that extends around at least a portion of the filling chamber, the second heating element configured to conductively heat the container.

20. The heater assembly of claim 19, wherein the second heating element comprises at least one of a heater that is wrapped around at least a portion of the outer surface of the container, a ceramic heater, a resistance wire embedded in ceramic, a positive temperature coefficient heater, a negative temperature coefficient heater, a film printed conductor on the outer surface of the container, or a conductive material that is joined to the outer surface of the container.

21. The heater assembly of claim 1, wherein the heat exchanger is formed from two or more separate components that are joined together.

22. The heater assembly of claim 1, wherein the heating element comprises at least one of a heater that is wrapped around at least a portion of an outer surface of the heat exchanger, a ceramic heater, a resistance wire embedded in ceramic, a positive temperature coefficient heater, a negative temperature coefficient heater, a film printed conductor on an outer surface of the heat exchanger, or a conductive material that is joined to the outer surface of the heat exchanger.

23. The heater assembly of claim 1, further comprising a sensor that is configured to measure at least one of a pressure of the air flow path or a mass of air flowing through the air flow path, and a microcontroller electrically coupled to the sensor, the microcontroller configured to determine when air is flowing through the air flow path based on a signal from the sensor.

24. A heater assembly for a vaporizer, comprising:
a housing comprising a heat exchanger that extends from a first end to a second end, the heat exchanger defining at least one air flow path that extends through the heat exchanger from the first end to the second end, and the housing configured to retain a substance adjacent the second end for heating;
a first electrical lead connected to a first portion of the heat exchanger; and
a second electrical lead connected to a second portion of the heat exchanger, wherein the first and second electrical leads are configured to conduct electric current that flows through the heat exchanger from the first portion to the second portion, the heat exchanger configured to increase in temperature as the electric current flows through the heat exchanger, and wherein the heat exchanger is configured to transfer heat to air flowing through the air flow path from the first end to the second end.

25. The heater assembly of claim 24, wherein the first portion of the heat exchanger is adjacent a first end of the heat exchanger and the second portion of the heat exchanger is adjacent a second end of the heat exchanger.

26. The heater assembly of claim 24, wherein the first portion of the heat exchanger is adjacent a first side of the heat exchanger and the second portion of the heat exchanger is adjacent a second side of the heat exchanger.

27. The heater assembly of claim 24, wherein the air flow path through the heat exchanger comprises a plurality of channels extending through the heat exchanger from the first end to the second end.
